(19) United States
(12) Patent Application Publication
(10) Pub. No.: US 2014/0092116 A1
(43) Pub. Date: Apr. 3, 2014

(54) WIDE DYNAMIC RANGE DISPLAY

(71) Applicant: Uti Limited Partnership, Calgary (CA)

(72) Inventors: Chika Antoinette Ofili, Calgary (CA); Stanislav Glozman, Beer-Sheva (IL); Orly Yadid-Pecht, Calgary (CA); Alain Hore, Calgary (CA)

(21) Appl. No.: 13/921,177

(22) Filed: Jun. 18, 2013

Related U.S. Application Data
(60) Provisional application No. 61/661,117, filed on Jun. 18, 2012.

(51) Int. Cl. G06T 11/00

(52) U.S. Cl. CPC G06T 11/001
USPC 345/589

(57) ABSTRACT

Methods and systems for wide dynamic range display are presented. In one embodiment, a method includes receiving a Color Filter Array (CFA) pixel signal, computing, using image processing hardware, an adaptation factor for the CFA pixel signal, the adaptation factor having a global factor component and a local factor component, and computing, using the image processing hardware, an adapted pixel signal for the CFA pixel in response to a reverse exponential function featuring the adaptation factor. In one embodiment, computing the adapted pixel signal for the CFA pixel does not require frame memory. Also, the adaptation factor may have a value between 0 and 1, in certain embodiments.

### CROSS-REFERENCE TO RELATED APPLICATIONS

This application claims the benefit of U.S. Provisional Patent Application No. 61/661,117 filed on Jun. 18, 2012, the entire contents of which is specifically incorporated herein by reference without disclaimer.

### BACKGROUND OF THE INVENTION

1. Field of the Invention

This invention relates to image display and more particularly relates to an apparatus system and method for wide dynamic range display.

2. Description of the Related Art

In imaging, dynamic range can be described as the luminance ratio between the brightest and darkest parts of a scene. Natural sceneries have a wide dynamic range that can exceed 100,000,000:1, while commonly used display devices have a limited dynamic range which is generally less than 1000:1.

Emerging image capture devices can produce wide dynamic range images, which have a higher dynamic range in comparison to the commonly used display devices. However, when these captured wide dynamic range images are displayed on commonly used devices, they appear to be over-exposed in well-lit scenes or under-exposed in dark scenes. Hence, image details will be lost when displayed. In order for the images to be accurately represented, a tone-mapping algorithm is used to adapt the captured wide dynamic range scenes to the low dynamic range displays available. Examples of such images are shown in the photographs submitted in U.S. Provisional Patent Application No. 61/661,117 ('117 App.) filed on Jun. 18, 2012, which is incorporated herein by reference in its entirety.

There are two main categories of tone-mapping algorithms; Tone Reproduction Curve (TRC) and Tone Reproduction Operator (TRO). Tone Reproduction curve which is also known as global tone mapping operator, maps all the image pixel values to a display value without taking into consideration the spatial location of the pixel in question. As a result, one input pixel value corresponds to only one output pixel value. On the other hand, Tone Reproduction Operator which is also called local tone-mapping operator is spatial location dependent and varying transformations are applied to each pixel depending on its surrounding. For this reason, one input pixel value may result in different output values.

There are trade-offs that occur based on the method of tone mapping used. TRC algorithms are generally less time consuming and require less computational effort but result in a loss of local contrast due to the global compression of the dynamic range. In general, while TRO algorithms do not result in a loss of local contrast, they require more computational effort and may introduce artifacts such as halos to the resulting compressed image. Consequently, TROs are less suitable for hardware implementation in comparison to TRC-based algorithms.

### SUMMARY OF THE INVENTION

Methods and systems for wide dynamic range display are presented. In one embodiment, a method includes receiving a Color Filter Array (CFA) pixel signal, computing, using image processing hardware, an adaptation factor for the CFA pixel signal, the adaptation factor having a global factor component and a local factor component, and computing, using the image processing hardware, an adapted pixel signal for the CFA pixel in response to an inverse exponential function featuring the adaptation factor. In one embodiment, computing the adapted pixel signal for the CFA pixel does not require frame memory. Also, the global factor and the local factor may have a value between 0 and 1, in certain embodiments.

In an embodiment, the method includes convolving the CFA pixel signal with a low-pass filter. The low-pass filter may be implemented according to a two-dimensional smoothing kernel. In another embodiment, the low-pass filter is a Gaussian filter. In still another embodiment, the low-pass filter is a Sigma filter. The convolution of the CFA pixel signal and the low-pass filter may be multiplied by the local factor component. Additionally, a mean intensity value of all CFA pixel intensities in an image is multiplied by the global factor component. The method may also include limiting the adapted pixel signal according to maximum display intensity.

In one embodiment, a system includes a control unit configured to receive a Color Filter Array (CFA) pixel signal. The system may also include an adaptation factor generator coupled to the control unit and configured to compute an adaptation factor for the CFA pixel signal, the adaptation factor having a global factor component and a local factor component. Additionally, the system may include an inverse exponential module configured to compute an adapted pixel signal for the CFA pixel in response to an inverse exponential function featuring the adaptation factor.

In an embodiment, the system may also include a convolution module configured to convolve the CFA pixel signal with a low-pass filter. The system may further include a limiter module configured to limit the adapted pixel signal according to maximum display intensity.

An embodiment of a tangible computer readable medium, comprising hardware executable code is also described. In one embodiment, when executed by the hardware, the hardware may perform operations including receiving a Color Filter Array (CFA) pixel signal, computing, using image processing hardware, an adaptation factor for the CFA pixel signal, the adaptation factor having a global factor component and a local factor component, and computing, using the image processing hardware, an adapted pixel signal for the CFA pixel in response to an inverse exponential function featuring the adaptation factor.

In another embodiment, a method includes obtaining wide dynamic range image data, calculating color filter array data associated with the wide dynamic range image data, and tone-mapping the color filter array data. In such an embodiment, tone-mapping the color filter array data further comprises calculating an adapted signal for each of a plurality of pixels in the wide dynamic range image data, the adapted signal being determined in response to the input light intensity at each respective pixel and other pixel data, but does not require a frame memory.

In an embodiment, the adapted signal has a value between 0 and 1. The adapted signal for each pixel may be calculated in response to an adaptation factor associated with each respective pixel. The adaptation factor may be calculated in response to two image key values, k1 and k2, for inducing brightness and local effects on the resulting image. In one embodiment, the image key factors k1 and k2 comprise a value from 0 to 1.

In one embodiment, calculating the adapted signal comprises applying a low-pass filter to the color filter array data associated with each respective pixel.

Another embodiment of a method may include obtaining wide dynamic range image data, calculating color filter array data associated with the wide dynamic range image data, applying a first tone-mapping algorithm to the color filter array data, computing an image mean μ from the result of the first tone-mapping algorithm, and applying a second tone-mapping algorithm to the color filter array data, wherein the second tone-mapping algorithm uses the image mean μ as an input to generate a tone-mapped image.

In such an embodiment, applying the first tone-mapping algorithm to the color filter array data may include calculating an adapted signal for each of a plurality of pixels in the wide dynamic range image data, the adapted signal being determined in response to the input light intensity at each respective pixel. The adapted signal for each pixel may be calculated in response to an adaptation factor associated with each respective pixel. In an embodiment, the adaptation factor is calculated in response to two image key values, k1 and k2, for inducing brightness and local effects on the resulting image. The image key value k1 may be a predetermined value calculated in response to an image mean value calculated for a pre-selected set of tone-mapped color filter array images, while the image key value k2 is a predetermined parameter that can be fixed between 0 and 1.

In one embodiment, applying the first tone-mapping algorithm to the color filter array data further comprises calculating a global operator for scaling the color filter array data associated with each respective pixel to a value between 0 and 1.

In an embodiment, the global operator is calculated according equation (10) below, where Lw represents the wide dynamic range image data, Lay the mean value of Lw, x and y the pixel locations, and Ld the resulting global tone-mapping operator.

Embodiments of an apparatus are also described. In one embodiment, the apparatus include an image capture device configured to capture wide dynamic range image data. The apparatus may also include a statistics circuit coupled to the image capture device, the statistics circuit configured to calculate mean and max values associated with the wide dynamic range image data for calculating color filter array data associated with the wide dynamic range image data. Additionally, the apparatus may include a tone-mapping circuit coupled to the image capture device and to the statistics circuit, the tone-mapping circuit configured to tone-map the color filter array data. In a further embodiment, the apparatus may include a key generator circuit coupled to the tone-mapping circuit, the key generator circuit configured to produce a key value for use by the tone-mapping circuit while applying the tone-mapping algorithm to the color filter array data. The apparatus may also include a convolution circuit coupled to the image capture device, and to the tone-mapping circuit, the convolution circuit configured to convolve the captured wide dynamic range image data with a low-pass filter.

The term “coupled” is defined as connected, although not necessarily directly, and not necessarily mechanically.

The terms “a” and “an” are defined as one or more unless this disclosure explicitly requires otherwise.

The term “substantially” and its variations are defined as being largely but not necessarily wholly what is specified as understood by one of ordinary skill in the art, and in one non-limiting embodiment “substantially” refers to ranges within 10%, preferably within 5%, more preferably within 1%, and most preferably within 0.5% of what is specified.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is an approach (top) and traditional image processing workflow (bottom).

FIG. 2 is an inverse exponent curves for different k₁ values.

FIG. 3 shows various image quality regions in relation to its image luminance and contrast.

FIG. 4 shows image luminance and contrast for tone-mapped WDR images.

FIG. 5 shows one embodiment of a method for automatic tuning of WDR images.

FIG. 6 shows a simple smoothing kernel according to one embodiment.

FIG. 7 is a schematic block diagram illustrating one embodiment of an image processing device for wide dynamic range display.

FIG. 8 shows a dataflow chart for operation of an embodiment of an image processing device for wide dynamic range display.

FIG. 9 is a state diagram of one embodiment of the controller of one embodiment of an image processing device for wide dynamic range display.

FIG. 10 is a state diagram of one embodiment of the controller of one embodiment of an image processing device for wide dynamic range display.

FIG. 11 shows a dataflow chart for operation of an embodiment of an image processing device for wide dynamic range display.

FIG. 12 shows a dataflow chart for operation of an embodiment of an image processing device for wide dynamic range display.

FIG. 13 shows a line buffer used in one embodiment of a convolution module.

FIG. 14 is a schematic block diagram illustrating one embodiment of a computer system.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

Embodiments of a pipelined tone mapping hardware architecture for WDR images based on an exponent-based algorithm are described. The algorithm comprises of a global and a local tone mapping operator. In addition, a proposed extension of this algorithm is also discussed. This extension involves the use of an automatic rendering technique for obtaining the rendering parameters that are used in obtaining the WDR compressed images. Hence, the algorithm can adjust its rendering parameters for a variety of different images. Consequently, the hardware architecture of the tone mapping system is more compact and does not require recalibration for different WDR images. Embodiments of the tone mapping architecture may be implemented using Verilog Hardware Description Language (HDL), or any other HDL and may be synthesized into a Field Programming Gate Array (FPGA) or an Application-Specific Integrated Circuit (ASIC). The present embodiments may be implemented according to various hardware implementations as described herein. Certain embodiments may require less hardware resources but results in fewer frames per second in comparison to other implementations. In certain embodiments, the system is implemented as part of a system-on-chip with WDR capabilities for biomedical, mobile, automotive and security surveillance applications.

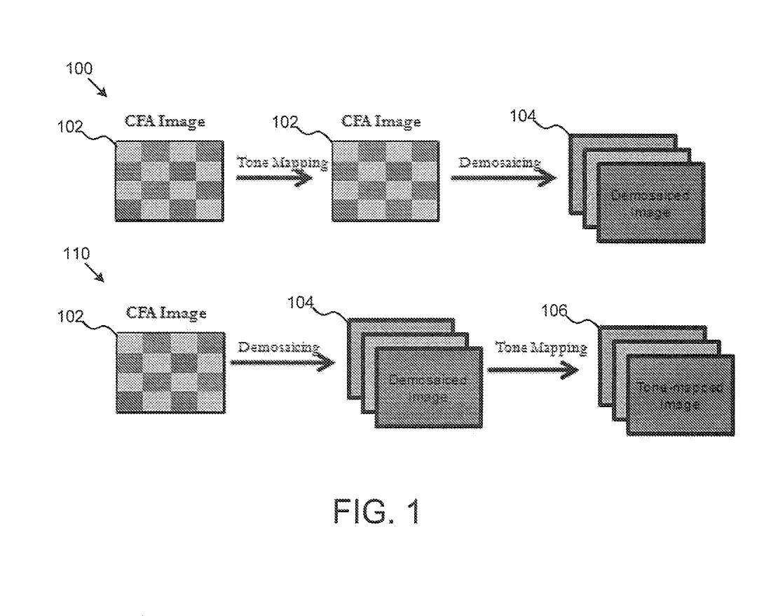

A method for tone-mapping, using TRO as a base, that does not require heavy computational effort and can be implemented in hardware is described. In an embodiment, the tone-mapping algorithm is implemented directly on the color filter array (CFA) data unlike traditional color processing workflows that implemented rendering operations after demosaicing the CFA image as shown in FIG. 1. Hence, only one third of the total pixels are processed, thereby reducing the computational complexity.

In the tone mapping algorithm, an inverse exponent function (1) is applied directly on the CFA.

$$Y ( p ) = 1 - {e}^{- \frac{X ( p )}{{X}_{o} ( p )}} \qquad ( 1 )$$

where p is a pixel in the image, X(p) represents specific CFA pixel's input light intensity, Y(p) is the pixel's adapted signal and Xo(p) is the adaptation factor of the specific CFA pixel (2). Xo(p) varies for each pixel p and comprises of both a global and a local component.

Xₒ(p)=k₁·X_{DC}+k₂·(X*F_{w})(p) (2)

where p is a pixel in the image; Xₒ(p) is the adaptation factor at pixel p; X_{DC} is the mean value of all the CFA image pixel intensities; denotes the convolution operation; and G_{H} is a two-dimensional Gaussian filter with spatial constant σ. The factor k₁ is a coefficient, which acts as a global factor that can be adjusted between 0 and 1 depending on the image key. It induces different local effects on the resulting image. The local factor of the adaptation function Xₒ(p) is the 2-D convolution of the input CFA pixel X(P) and a low-pass filter F_{w}. In one embodiment, a Gaussian filter is used. Various image filters, preferably low-pass filters, can be used in different embodiments. k₂ is an adaptation factor that varies from [0 1]. In one embodiment, k₂ may be used to control the amount of local adaptation in the resulting image. The lower the value of k₂, the lower the amount of image details and the higher the global contrast of the tone-mapped image.

A scaling coefficient may be added to equation (1) so as to ensure that all the tone mapping curves will start at the origin and meet at X(p)=Xₘₐₓ.

$$Y ( p ) = \frac{α}{( 1 - {e}^{- \frac{{X}_{max}}{{X}_{o} ( p )}} )} \cdot ( 1 - {e}^{- \frac{X ( p )}{{X}_{o} ( p )}} ) \qquad ( 3 )$$

where α is the maximum pixel intensity of the display device. For standard devices such as a computer monitor, α=255 (8 bits). The equation's solution for a full range of Xε[0: Xₘₐₓ] is almost a logarithmic curve, which is known as the best representation of the Human Visual system's response to Light.

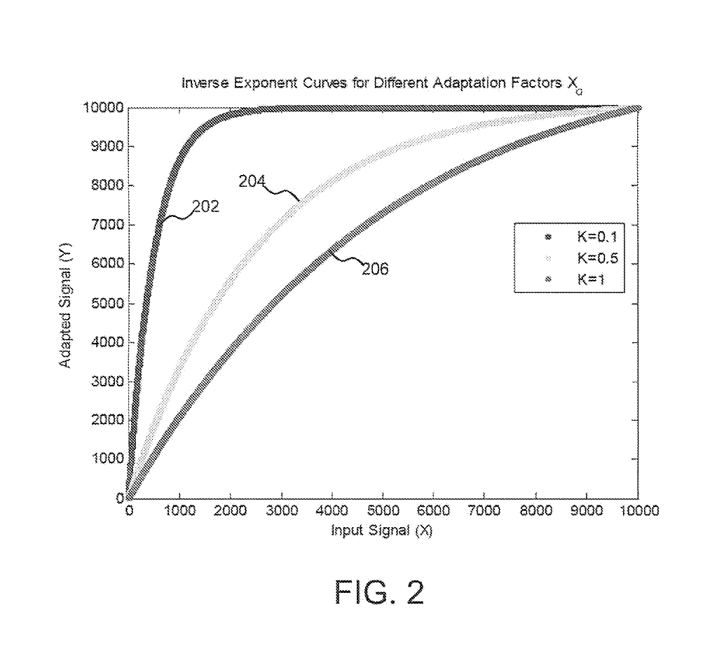

The equation described above (2) has two rendering parameters that differ for WDR images, which are the k₁ and k₂ factors. k₁ is a global tone correction and can be adjusted between 0 and 1 depending on the image key. Low and high key images are images that have a mean intensity that is lower or higher than the average. k₁ factor values closer to 0 are needed for low key images, while values closer to 1 are needed for high key images. This is because the lower the k₁ value, the higher the image contrast, thereby increasing the brightness of the image. On the other hand, the higher the k₁ value, the higher the compression of higher pixel values, which causes the overall image to appear less exposed as shown in FIG. 2. k₂ is a predetermined parameter that controls the amount local adaptation in an image, and it ranges from 0 to 1.

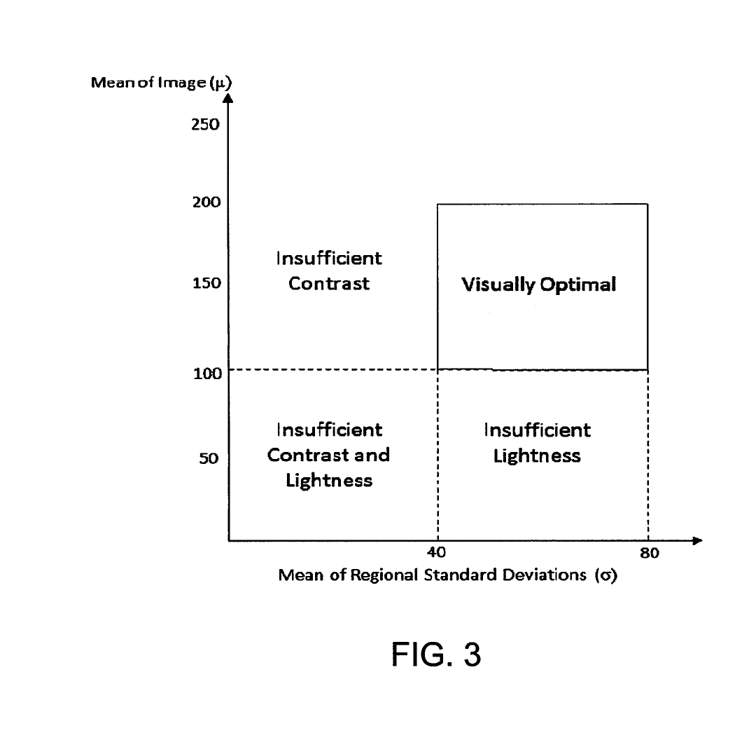

Using the statistical methods, an appropriate k₁ value for 200 WDR images is found. This method is used to relate a visually pleasant image to a visually optimal region in terms of its image luminance and contrast, as shown in FIG. 3. In one embodiment, the overall image luminance is measured by calculating the image's mean μ, while the overall contrast a, is measured by calculating the mean of the regional standard deviations. A visually optimal image may have a high image contrast which is within 40-80, while its image luminance near the midpoint of its dynamic range, i.e. 128 for an 8 bit image, in order to have a well spread histogram.

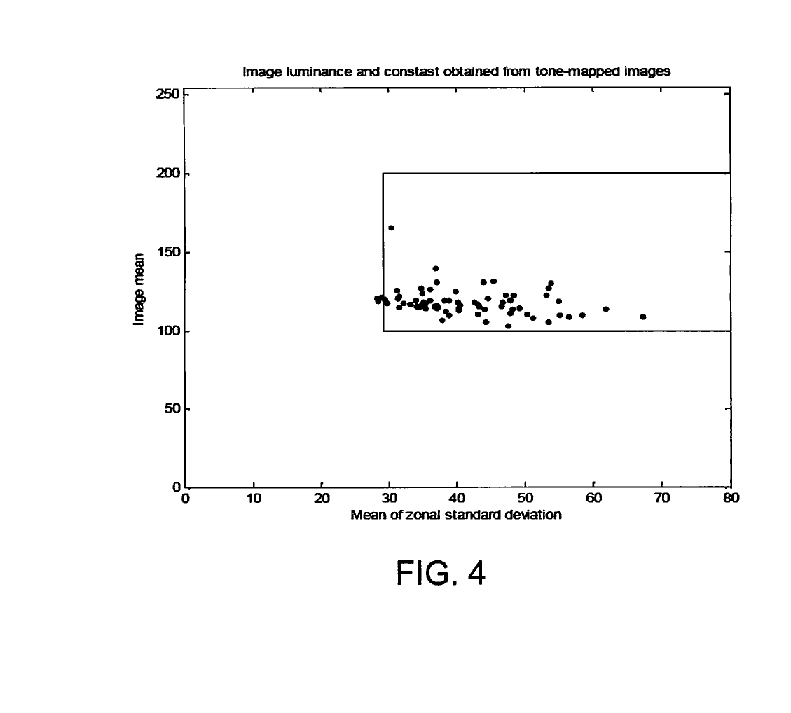

To obtain the regional blocks, area blocks of 50×50 pixel size may be used to calculate the standard deviation of a pixel region, in one embodiment. Since embodiments the tone mapping algorithm use the CFA of an image instead of the RGB image, the calculation of the overall image luminance and contrast may be based on the mean of the CFA and the mean of the regional standard deviations respectively. Tests performed on several WDR images showed that the embodiments were effective with the tone mapping algorithm for the visually satisfactory tone mapped images as shown in FIG. 4.

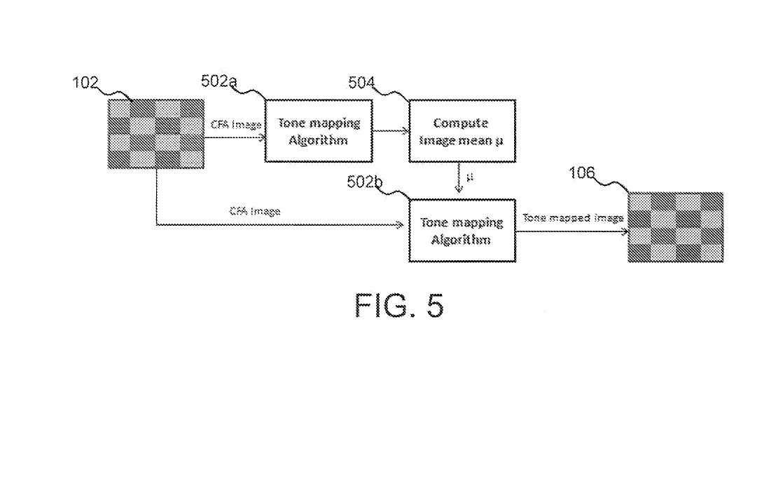

Using the data obtained for the visually optimal tone mapped images various embodiments of methods for automatic tuning of k₁-factor for any given image may be used. Embodiments may utilize the same algorithm pathway, as described in FIG. 5. In one embodiment, an estimation of the image statistics may be performed after an initial compression of the WDR image. Using the values obtained, the appropriate key, k₁ may be obtained and used for the actual tone mapping embodiments.

In one embodiment, the method may include obtaining an initial tone mapping. This embodiment may be beneficial because a WDR image could vary in the mean, maximum value and the dynamic range. Hence, having a standard level where the image properties can be evaluated may make obtaining a proper estimate of the k₁-factor easier. The methods used in estimating this rendering parameter differs in the type of tone mapping algorithm used in the initial step.

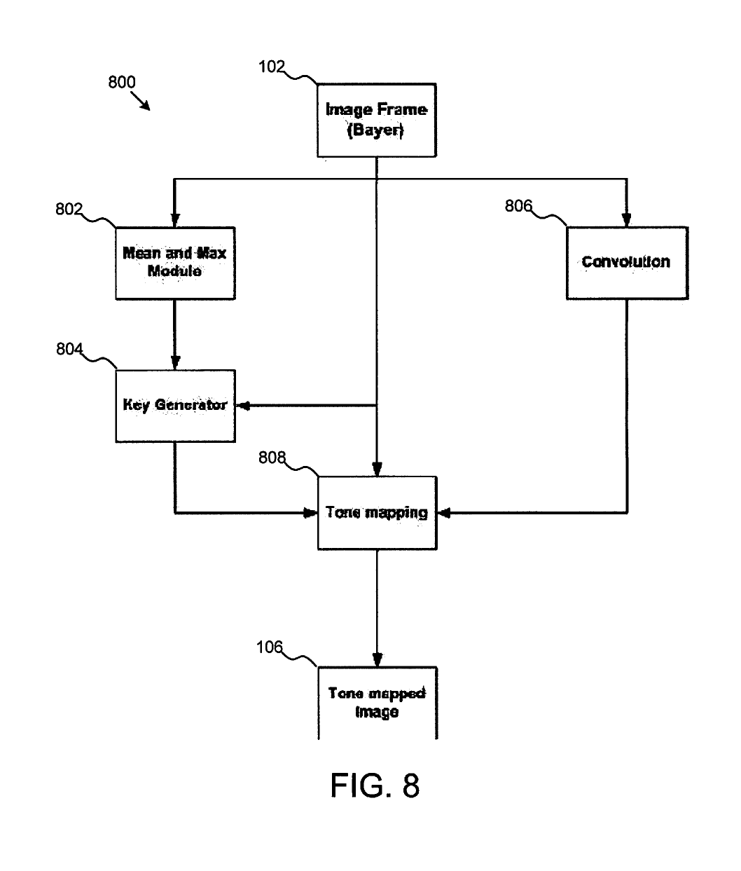

In one embodiment, the technique utilizes the exponent operator based algorithm, as described in equation 1-2 as the initial compression. To obtain the k₁-equation, the mean of the tone-mapped CFA image (at k₁=0.5) may be stored for all 200 images used, in one embodiment. The sigma and kernel size for the Gaussian filter was set at X=Y=8 and σ=1 respectively. In one embodiment, there may be a correlation between the tone mapped image's mean Ym, and the optimal k factor value as shown in FIG. 8. To obtain a relatively simple equation, the result was divided into three regions (A, B, C). Using a curve fitting tool, a k₁-equation (4) may be obtained. The root mean square error (RMSE) for the curve obtained in Region B was found to be 0.0342.

$$\begin{matrix}{k}_{1} = \{ \begin{matrix}a & x \leq {R}_{1} \\ c \cdot {2}^{d \cdot x} & {R}_{1} < x < {R}_{3} \\ b & x \geq {R}_{3}\end{matrix} & ( 4 ) \\ x = {y}_{m} & ( 5 )\end{matrix}$$

where yₘ is the mean of the image obtained from the initial compression.

In another embodiment, the scaling factor may be removed and a simplified version of Eq. (3) may be implemented as:

$$\begin{matrix}Y ( p ) = α \cdot ( 1 - {e}^{- \frac{X ( p )}{{X}_{o} ( p )}} ) & ( 6 ) \\ {X}_{o} ( p ) = {k}_{1} \cdot {X}_{DC} + {k}_{2} \cdot ( X * {F}_{w} ) ( p ) & ( 7 )\end{matrix}$$

In such an embodiment, 200 samples may be used. In such an embodiment, k₁ may be expressed as:

$$\begin{matrix}{k}_{1} = \{ \begin{matrix}a & x \leq {R}_{1} \\ c \cdot {2}^{d \cdot x} & {R}_{1} < x < {R}_{3} \\ b & x \geq {R}_{3}\end{matrix} & ( 8 ) \\ x = {y}_{m} & ( 9 )\end{matrix}$$

where yₙ, is the mean of the image obtained from the initial compression. This equation had a root mean square error (RMSE) of 0.0359.

In another embodiment, the method may utilize a simpler tone mapping algorithm at the first stage. The tone mapping equation may be a global operator. Consequently, it may not take into account the neighboring pixel values. This simple exponential function scales the CFA image from 0 (black pixels) and 1 (white pixels), which correspond to pixel values greater than the average of the image Lₐᵥ.

$${L}_{d} ( x , y ) = 1 - exp ( - \frac{{L}_{w} ( x , y )}{{L}_{av}} ) \qquad ( 10 )$$

Using a curve fitting tool, a k₁-equation (11-12) was obtained. This equation had a root-mean square error (RMSE) value of 0.0499, which is higher than the one the RMSE obtained from Method 1. That implies that Method 1 is more accurate in estimating the k₁ factor than Method 2.

$$\begin{matrix}{k}_{1} = \{ \begin{matrix}a & x \leq {R}_{1} \\ c \cdot {2}^{d \cdot x} & {R}_{1} < x < {R}_{3} \\ b & x \geq {R}_{3}\end{matrix} & ( 11 ) \\ x = {y}_{m} & ( 12 )\end{matrix}$$

where yₘ is the mean of the image obtained from the initial compression.

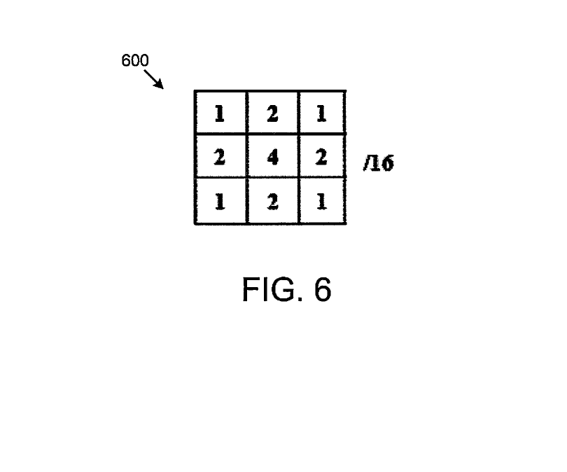

With tone mapping operators that involve local processing, artifacts such as halos could occur. This is because the pixels in close proximity to a specified pixel could have a very different light intensity that could result in contrast reversals. To reduce the possible of halo artifacts, a simple 3×3 kernel filter may be used instead as shown in FIG. 6. The images produced with this kernel may have far less halos in comparison to that produced with a true Gaussian filter. This will also be advantageous in the hardware implementation because it will require less hardware resources in comparison to larger kernel sizes. In other embodiments, different sized kernels, such as 5×5 kernels may be used for different optimizations. In still other embodiments, different types of filters, such as sigma filters, may be used. One of ordinary skill in the art will recognize the tradeoffs, in terms of resource usage and quality of results, in using different kernel sizes and filter types. For example, a sigma filter may preserve details of the image better than a Gaussian filter, depending upon the implementation.

For the hardware implementation, a fixed point precision instead of floating point precision may be used so as to reduce the hardware complexity. In one embodiment, the fixed point representation may be 20 bits for integer and 12 bits for fraction. As a result, a 32-bit word length may be used for the tone mapping system. With the number of fractional bits as 12 bits, the quantization error may be on the order of 2.44140625 e-4.

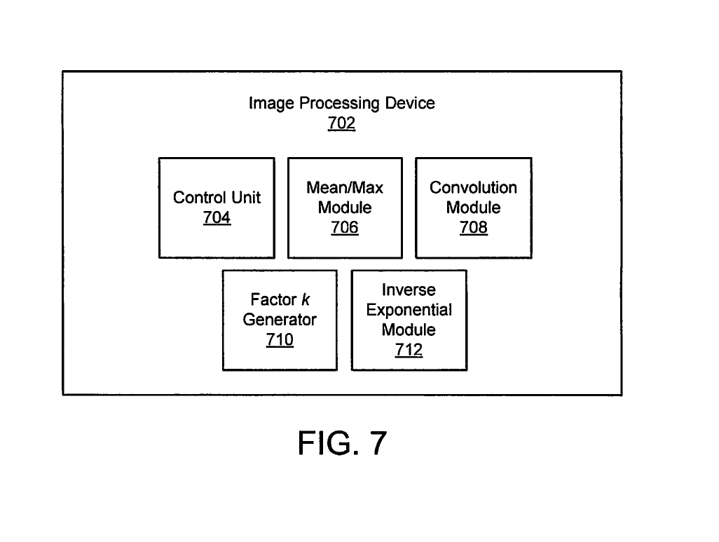

An embodiment of an image processing device 702 is shown in FIG. 7. In one embodiment, the image processing device 702 includes a control unit 704, a mean/max calculation module 706, a convolution calculator module 708, a factor k₁, k₂ generator 710, and an inverse exponential calculator module 712. The various modules of the image processing device 702 may be implemented in hardware. In another embodiment, the various modules may be implemented as software defined modules which may be stored as executable code on a tangible computer readable medium and configured to execute on a data processor to cause the data processor to operate according the description of the methods and modules herein. In still another embodiment, the image processing device 702 may be implemented as a combination of hardware and software or firmware. For example, the hardware architecture may be implemented in Verilog HDL, in one embodiment.

An embodiment of a dataflow of the proposed tone mapping algorithms is described in FIG. 8. The processing may be performed on a pixel by pixel basis. First the image may be stored temporarily stored in a memory buffer and then each pixel is continuously processed by the tone mapping system using the modules of image processing device 702 as described below. There may be multiple different approaches implemented for the image processing device 702. Such embodiments may utilize the modules that will be discussed below but differ in the implementation of the control unit module.

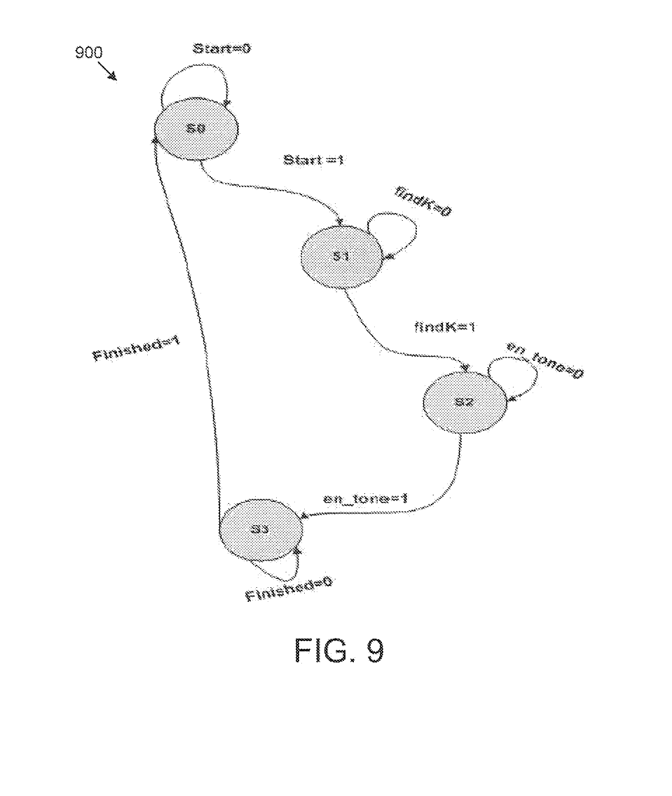

In one embodiment, the control unit 704 of the image processing device 702 may be implemented as finite state machines (FSM). In an embodiment, the control unit 704 may generate the control signals to synchronize the overall tone mapping process as illustrated in FIG. 9.

In one embodiment, the control module 704 may be configured to operate according to four primary states:

S0: In state S0, all modules remain idle until the enable signal Start is set as high.

S1: Here, the mean, max and image convolution modules are performed in parallel. An enable signal is sent to the external memory that results in one input pixel been sent at each Clock. Once all three computations have been complemented and stored, an enable signal findK is set high and the FSM moves to S2.

S2: In this state, the mean of the WDR image is used in the estimation of the rendering parameter that will be used in the tone mapping stage. Once that calculation is complete, the signal en_tone will be set as ‘1” and the FSM moves to S2.

S3: This is where the actual tone mapping algorithm is implemented, using the information generated from S1 and S2, the image pixels are read from the memory and are compressed. Then the tone mapped output pixels are read out to memory. An end signal finished is set high, and the FSM returns to S0.

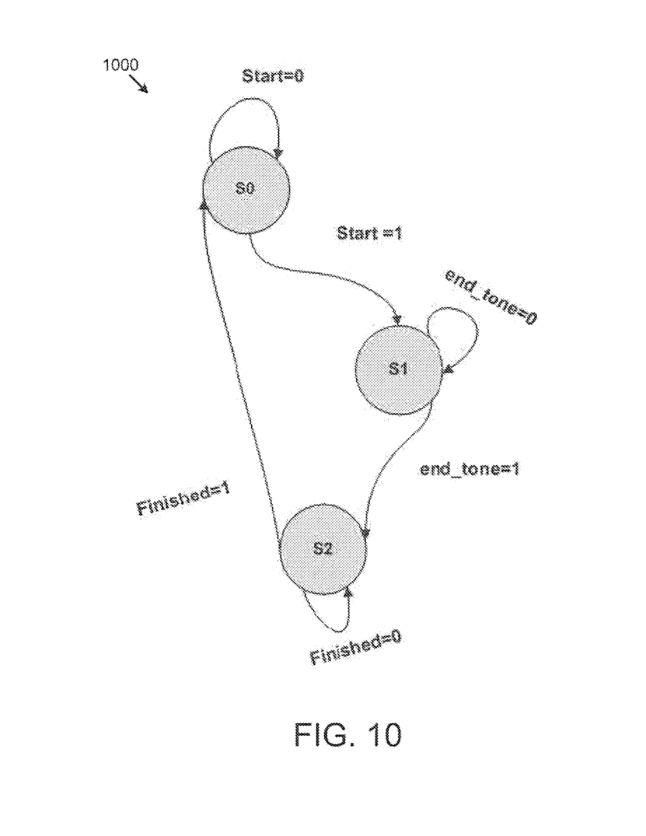

On the other hand, the alternative implementations may have only three main states, for example in the embodiment illustrated in FIG. 10. In such an embodiment, the statistical information needed for the current frame such as mean value, max value, factor k₁ is obtained from the previous frame. This is because neighboring frames in a video sequence may have very few discrepancies. Therefore, global statistics such as histogram, maximum and minimum luminance values of the neighboring frames may remain practically the same.

The three states are illustrated in FIG. 10 include:

S0: In state S0, all modules remain idle until the enable signal Start is set as high.

S1: An enable signal is sent to the external memory that results in one input pixel been sent at each Clock. The input pixel is used in computing the mean, max, factor-k₁ estimation block, image convolution and actual tone mapping algorithm. The values from the convolution module are used along with the input pixels in the actual computation of the tone mapping algorithm. The mean, maximum and factor k₁, of the previous frame is used in current frame tone mapping computation. Once all four computations have been completed and stored, an enable signal end_tone is set high and the FSM moves to S2.

S2: In this state, the mean, max and factor k₁ of the current WDR frame is stored for the next frame image processing. An end signal finished is set high and the FSM returns to S0 if there is a next WDR frame.

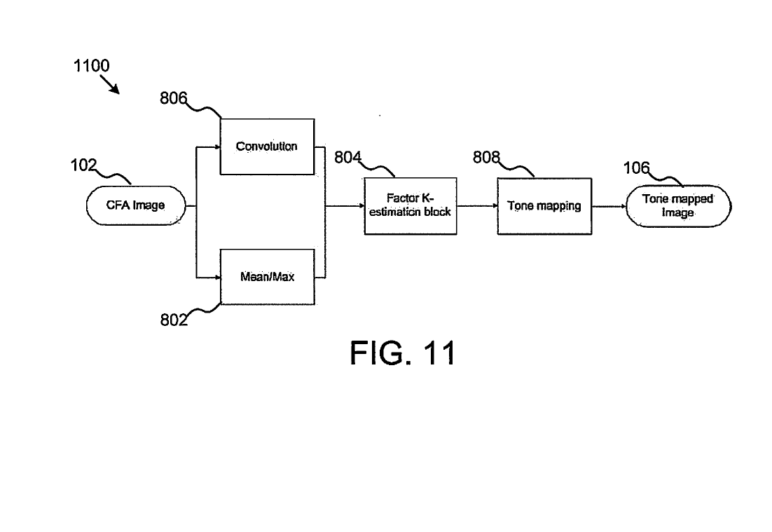

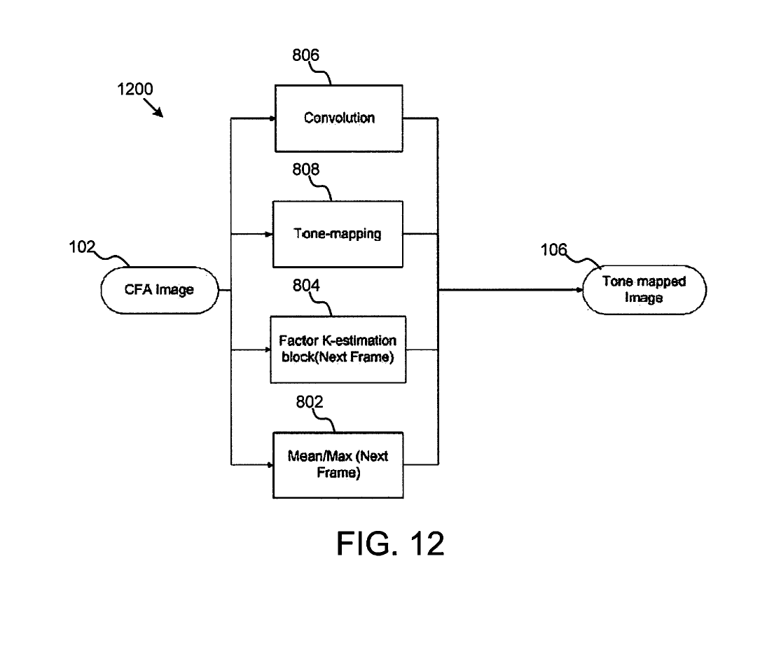

Illustrations of the processing stages involved in various embodiments are shown in FIG. 11 and FIG. 12. In order to implement the alternative hardware implementation, certain modules may be executed in parallel.

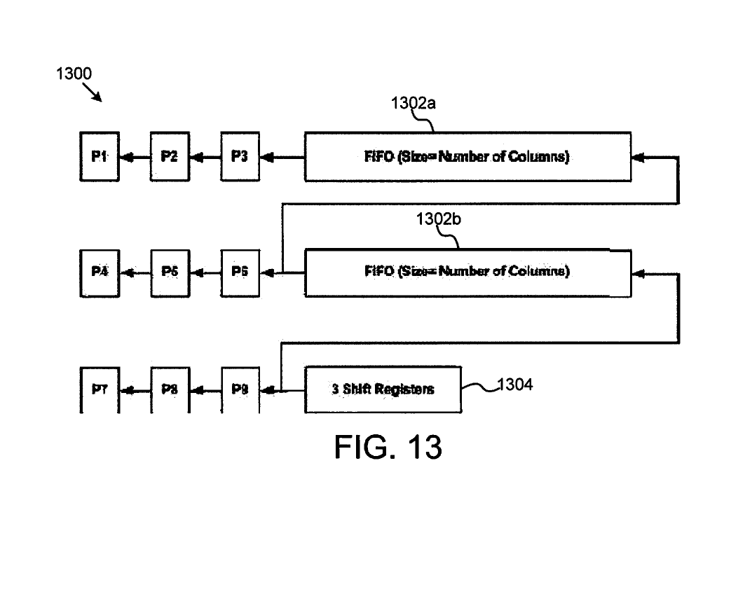

In one embodiment of the convolution module 708, a convolution kernel may be used for obtaining the information of the neighboring pixels. An embodiment of a 3×3 convolution kernel is illustrated in FIG. 6. One of ordinary skill will recognize that alternative kernel sizes, such as 5×5 convolutional kernels may be similarly implemented in the convolution module 708. These simple kernels may be used so that the output pixels can be calculated without the use of multipliers. The kernel size is also adequate because this will reduce the possibility of having halo artifacts in the tone mapped image. The convolution module 708 may be divided into two sub-modules; a data pixel input generation module, and a smoothing module. To execute a pipelined convolution, 2 FIFO 1302a, b and 3 Shift registers 1304 may be used as illustrated in FIG. 13. The 2 FIFO 1302a, b and the 3-shift registers 1304 may act as a line buffer for the convolution module 708. At every clock, as new input enters this line buffer resulting in an updated 3×3 input pixels (P1-P9). The nine updated input pixels may enter the smoothing module and be used for further calculation.

Inside the smoothing module, the output pixel may be calculated by the use of simple adders and shift registers, hence removing the need for multipliers and dividers which are expensive in terms of hardware resources.

In one embodiment, the mean/max module 706 may be implemented as an lpm_divide from Altera. The lpm_divide may be used to calculate the mean of the CFA image. But since the mean module may work for at least 1024×768 pixel resolution, a simplification may be implemented to avoid the use of even bigger bits in the divider module. The larger the number of bits required in the numerator and dominator of the divider module, the larger the latency required and hardware resources used. Shift registers may be used as the initial division of the sum of the image pixels. For example, for a 1024×768 frame size, the total number of pixels is 12×216. To calculate the mean, the summation of the pixels may be computed, then a shift to the left by 16 bits may be performed which is the same as dividing the sum of the pixels by 216. That means that in the divider module, the divider was the value 12. To improve the frequency of the divider module, the pipelined option for the lpm_divide may be selected, in one embodiment.

In one embodiment, the inverse exponential module 712 may be implemented as a modification of a digit-by-digit algorithm for implementing exponential functions. In an embodiment, the tone mapping algorithm is an inverse exponential equation which will require more dividers than used in previous methods. For any arbitrary value of x, e^{x} can represented as e^{(I+f)·ln2}

y=e^{x}=e^{(I+f)·ln2}=e^{I·ln2+f·ln2}=2^{I}e^{f·ln2} (13)

I+f=x·log₂e (14)

where, I and f are the integer and fractional parts of the value x. To obtain I and f=x·log₂e. Since f·ln2 ranges from 0 to ln2, the Taylor series approximation (15) of exponential equation can be used until its 3rd order.

$${e}^{x} = 1 + \frac{x}{1 !} + \frac{{x}^{2}}{2 !} + \frac{{x}^{3}}{3 !} \qquad ( 15 )$$

Since embodiments of the equation used in the tone mapping algorithm is an inverse exponent e^{-x}. The following assumptions may be made:

$$1 - {e}^{- x} = \{ \begin{matrix}A & x \leq 8 \\ 1 & x > 8\end{matrix} \\ A = 1 - {2}^{- I} {e}^{fln} \\ {e}^{- fln 2} = 1 - \frac{fln 2}{1 !} + \frac{{( fln 2 )}^{2}}{2 !} - \frac{{( fln 2 )}^{3}}{3 !} \qquad ( 16 )$$

The assumption in equation 16 was made because e⁻⁹=1.2341 e-4 which is smaller than the quantization error of the tone mapping architecture.

In one embodiment of the factor k₁ generator 710, a method similar to the inverse exponential module was used. As seen in equation 11, the k₁-equation may be in the form of power of 2. To improve the accuracy of the module 710, the approach used in the digit-by-digit algorithm and the inverse exponential block may be used.

y=2^{x}=2^{I+F}=2^{I}·e^{(ln2)·F} (17)

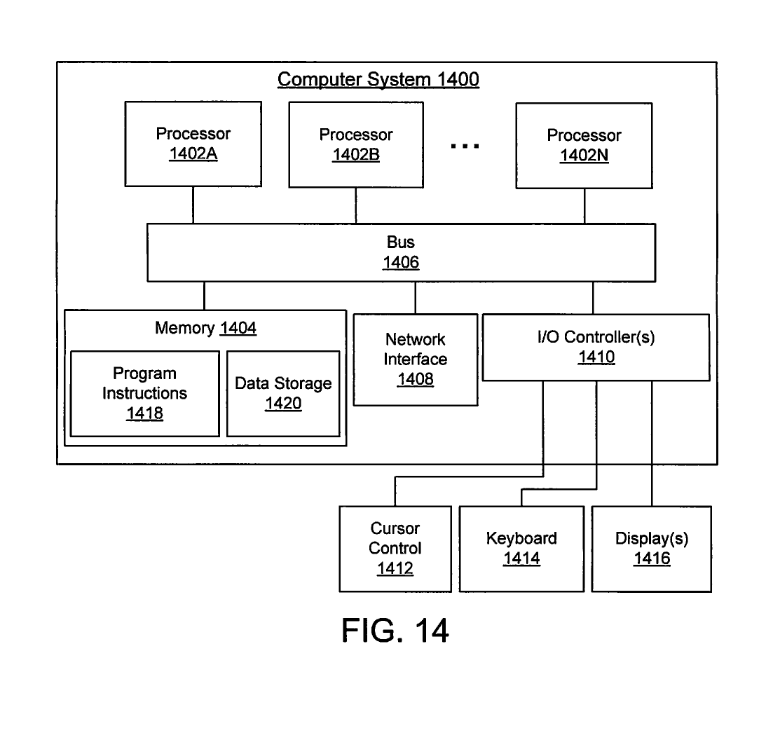

FIG. 14 is a schematic block diagram illustrating one embodiment of a computer system 1400 configurable for tone mapping. In one embodiment, FIG. 7 may be implemented on a computer system similar to the computer system 1400 described in FIG. 14. Similarly, tone mapping algorithm 502 and computation of image mean 504 of FIG. 5 may be implemented in computer system of FIG. 14. In other embodiments, steps described in blocks 802-808 may also be implemented on a computer system similar to the computer system 1400. In various embodiments, computer system 1400 may be a server, a mainframe computer system, a workstation, a network computer, a desktop computer, a laptop, or the like.

As illustrated, computer system 1400 includes one or more processors 1402A-N coupled to a system memory 1404 via bus 1406. Computer system 1400 further includes network interface 1408 coupled to bus 1406, and input/output (I/O) controller(s) 1410, coupled to devices such as cursor control device 1412, keyboard 1414, and display(s) 1416. In some embodiments, a given entity (e.g., image processing device 702) may be implemented using a single instance of computer system 1400, while in other embodiments multiple such systems, or multiple nodes making up computer system 1400, may be configured to host different portions or instances of embodiments (e.g., control unit 704).

In various embodiments, computer system 1400 may be a single-processor system including one processor 1402A, or a multi-processor system including two or more processors 1402A-N (e.g., two, four, eight, or another suitable number). Processor(s) 1402A-N may be any processor capable of executing program instructions. For example, in various embodiments, processor(s) 1402A-N may be general-purpose or embedded processors implementing any of a variety of instruction set architectures (ISAs), such as the x86, POWERPC®, ARM®, SPARC®, or MIPS® ISAs, or any other suitable ISA. In multi-processor systems, each of processor(s) 1402A-N may commonly, but not necessarily, implement the same ISA. Also, in some embodiments, at least one processor(s) 1402A-N may be a graphics processing unit (GPU) or other dedicated graphics-rendering device.

System memory 1404 may be configured to store program instructions and/or data accessible by processor(s) 1402A-N. For example, memory 1404 may be used to store software program and/or database shown in FIGS. 8-12. In various embodiments, system memory 1404 may be implemented using any suitable memory technology, such as static random access memory (SRAM), synchronous dynamic RAM (SDRAM), nonvolatile/Flash-type memory, or any other type of memory. As illustrated, program instructions and data implementing certain operations, such as, for example, those described above, may be stored within system memory 1404 as program instructions 1409 and data storage 1410, respectively. In other embodiments, program instructions and/or data may be received, sent or stored upon different types of computer-accessible media or on similar media separate from system memory 1404 or computer system 1400. Generally speaking, a computer-accessible medium may include any tangible, non-transitory storage media or memory media such as electronic, magnetic, or optical media—e.g., disk or CD/DVD-ROM coupled to computer system 1400 via bus 1406, or non-volatile memory storage (e.g., “flash” memory)

The terms “tangible” and “non-transitory,” as used herein, are intended to describe a computer-readable storage medium (or “memory”) excluding propagating electromagnetic signals, but are not intended to otherwise limit the type of physical computer-readable storage device that is encompassed by the phrase computer-readable medium or memory. For instance, the terms “non-transitory computer readable medium” or “tangible memory” are intended to encompass types of storage devices that do not necessarily store information permanently, including for example, random access memory (RAM). Program instructions and data stored on a tangible computer-accessible storage medium in non-transitory form may further be transmitted by transmission media or signals such as electrical, electromagnetic, or digital signals, which may be conveyed via a communication medium such as a network and/or a wireless link.

In an embodiment, bus 1406 may be configured to coordinate I/O traffic between processor 1402, system memory 1404, and any peripheral devices including network interface 1408 or other peripheral interfaces, connected via I/O controller(s) 1410. In some embodiments, bus 1406 may perform any necessary protocol, timing or other data transformations to convert data signals from one component (e.g., system memory 1404) into a format suitable for use by another component (e.g., processor(s) 1402A-N). In some embodiments, bus 1406 may include support for devices attached through various types of peripheral buses, such as a variant of the Peripheral Component Interconnect (PCI) bus standard or the Universal Serial Bus (USB) standard, for example. In some embodiments, the operations of bus 1406 may be split into two or more separate components, such as a north bridge and a south bridge, for example. In addition, in some embodiments some or all of the operations of bus 1406, such as an interface to system memory 1404, may be incorporated directly into processor(s) 1402A-N.

Network interface 1408 may be configured to allow data to be exchanged between computer system 1400 and other devices, such as other computer systems attached to image processing device 702, for example. In various embodiments, network interface 1408 may support communication via wired or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

I/O controller(s) 1410 may, in some embodiments, enable connection to one or more display terminals, keyboards, keypads, touch screens, scanning devices, voice or optical recognition devices, or any other devices suitable for entering or retrieving data by one or more computer system 1400. Multiple input/output devices may be present in computer system 1400 or may be distributed on various nodes of computer system 1400. In some embodiments, similar I/O devices may be separate from computer system 1400 and may interact with computer system 1400 through a wired or wireless connection, such as over network interface 1408.

As shown in FIG. 14, memory 1404 may include program instructions 1409, configured to implement certain embodiments described herein, and data storage 1410, comprising various data accessible by program instructions 1418. In an embodiment, program instructions 1418 may include software elements of embodiments illustrated in FIGS. 8-13. For example, program instructions 1418 may be implemented in various embodiments using any desired programming language, scripting language, or combination of programming languages and/or scripting languages. Data storage 1410 may include data that may be used in these embodiments such as, for example, CFA image frames 102, tone mapped images 106, or various bits corresponding to pixels at various stages therebetween. In other embodiments, other or different software elements and data may be included.

A person of ordinary skill in the art will appreciate that computer system 1400 is merely illustrative and is not intended to limit the scope of the disclosure described herein. In particular, the computer system and devices may include any combination of hardware or software that can perform the indicated operations. In addition, the operations performed by the illustrated components may, in some embodiments, be performed by fewer components or distributed across additional components. Similarly, in other embodiments, the operations of some of the illustrated components may not be performed and/or other additional operations may be available. Accordingly, systems and methods described herein may be implemented or executed with other computer system configurations.

Embodiments of image processing device 702 described in FIG. 7 may be implemented in a computer system that is similar to computer system 1400. In one embodiment, the elements described in FIGS. 8-13 may be implemented in discrete hardware modules. Alternatively, the elements may be implemented in software-defined modules which are executable by one or more of processors 1402A-N, for example.

Embodiments of a hardware implementation of a local tone-mapping algorithm for color wide dynamic range images (WDR) have been presented. An ideal tone-mapping algorithm should be able to automatically adjust its rendering parameters for different WDR images. An automatic parameter selector has been proposed for the original tone mapping algorithm so as to produce good tone-mapped images without manual tuning of rendering parameters. The hardware implementation is described in Verilog and synthesized for a FPGA. Alternatively, the algorithm may be implemented in software-defined modules, firmware-defined modules or the like, which are configured to operate on a data processing device. Results show that the hardware architecture produces images that have good visual quality that can be compared to software-based local tone-mapping algorithms. High PSNR (peak signal-to-noise ratio) and high SSIM (structural similarity index measure) scores were obtained when the results were compared with output images obtained from software simulations using MATLAB. Furthermore, the proposed system is highly efficient in terms of power consumption and hardware complexity for an FPGA-based design and a following ASIC design.

All of the methods disclosed and claimed herein can be made and executed without undue experimentation in light of the present disclosure. While the apparatus and methods of this invention have been described in terms of preferred embodiments, it will be apparent to those of skill in the art that variations may be applied to the methods and in the steps or in the sequence of steps of the method described herein without departing from the concept, spirit and scope of the invention. In addition, modifications may be made to the disclosed apparatus and components may be eliminated or substituted for the components described herein where the same or similar results would be achieved. All such similar substitutes and modifications apparent to those skilled in the art are deemed to be within the spirit, scope, and concept of the invention as defined by the appended claims.

1. A method for low-power pixel processing comprising:
receiving a Color Filter Array (CFA) pixel signal;
computing, using image processing hardware, an adaptation factor for the CFA pixel signal, the adaptation factor having a global factor component and a local factor component; and
computing, using the image processing hardware, an adapted pixel signal for the CFA pixel in response to an inverse exponential function featuring the adaptation factor.

2. The method of claim 1, wherein computing the adapted pixel signal for the CFA pixel does not require frame memory.

3. The method of claim 1, wherein the global factor and the local factor have a value between 0 and 1, and have a variable value depending upon different pixels of a wide dynamic range image.

4. The method of claim 1, further comprising convolving the CFA pixel signal with a low-pass filter.

5. The method of claim 4, wherein the low-pass filter is implemented according to a two-dimensional smoothing kernel.

6. The method of claim 4, wherein the low-pass filter is a Gaussian filter.

7. The method of claim 4, wherein the low-pass filter is a Sigma filter.

8. The method of claim 4, wherein the convolution of the CFA pixel signal and the low-pass filter are multiplied by the local factor component.

9. The method of claim 1, wherein a mean intensity value of all CFA pixel intensities in an image is multiplied by the global factor component.

10. The method of claim 1, further comprising limiting the adapted pixel signal according to a maximum display intensity.

11. A system for low-power pixel processing comprising:
a control unit configured to receive a Color Filter Array (CFA) pixel signal;
an adaptation factor generator coupled to the control unit and configured to compute an adaptation factor for the CFA pixel signal, the adaptation factor having a global factor component and a local factor component; and
an inverse exponential module configured to compute an adapted pixel signal for the CFA pixel in response to an inverse exponential function featuring the adaptation factor.

12. The system of claim 11, wherein computing the adapted pixel signal for the CFA pixel does not require frame memory.

13. The system of claim 11, wherein the global factor and the local factor have a value between 0 and 1, and have a variable value depending upon different pixels of a wide dynamic range image.

14. The system of claim 11, further comprising a convolution module configured to convolve the CFA pixel signal with a low-pass filter.

15. The system of claim 14, wherein the low-pass filter is implemented according to a two-dimensional smoothing kernel.

16. The system of claim 14, wherein the low-pass filter is a Gaussian filter.

17. The system of claim 14, wherein the low-pass filter is a Sigma filter.

18. The system of claim 14, wherein the convolution of the CFA pixel signal and the low-pass filter are multiplied by the local factor component.

19. The system of claim 11, wherein a mean intensity value of all CFA pixel intensities in an image is multiplied by the global factor component.

20. The system of claim 11, further comprising a limiter module configured to limit the adapted pixel signal according to a maximum display intensity.

21. A tangible computer readable medium, comprising hardware executable code, that when executed by the hardware, causes the hardware to perform operations comprising:
receiving a Color Filter Array (CFA) pixel signal;
computing, using image processing hardware, an adaptation factor for the CFA pixel signal, the adaptation factor having a global factor component and a local factor component; and
computing, using the image processing hardware, an adapted pixel signal for the CFA pixel in response to a reverse exponential function featuring the adaptation factor.
